(19) United States
(12) Patent Application Publication
(10) Pub. No.: US 2001/0051175 A1
(43) Pub. Date: Dec. 13, 2001

(54) Aqueous dispersions of agricultural chemicals

(76) Inventors: Robert M. Strom, Midland, MI (US); D. Claude Price, Midland, MI (US); Steven D. Lubetkin, Zionsville, IN (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/865,360

(22) Filed: May 25, 2001

Related U.S. Application Data
(63) Continuation-in-part of application No. 09/546,270, filed on Apr. 10, 2000, now abandoned.
(60) Provisional application No. 60/128,994, filed on Apr. 12, 1999.

(51) Int. Cl. A01N 25/00

(52) U.S. Cl. 424/405

(57) ABSTRACT

The bioavailability of a pesticide can be increased by formulating the pesticide as a stable aqueous dispersion of particles in the micron or submicron range. Such a formulation has the further advantage of substantially reducing or eliminating the need for organic solvents. Moreover, the stable aqueous dispersion provides a means of preparing a one part formulation of a plurality of pesticides which would be otherwise unstable in each other's presence.

### CROSS-REFERENCE STATEMENT

This application is a Continuation-In-Part (CIP) of prior application Ser. No. 09/546,270, which claims the benefit of U.S. Provisional Application No. 60/128,994, filed Apr. 12, 1999.

### BACKGROUND OF THE INVENTION

The present invention relates to an aqueous dispersion of particles having pesticidal activity. In particular, the present invention relates to dispersions of micron- or sub-micron-sized particles.

The efficient use of pesticides is often restricted somewhat by their inherent poor water-solubility. Generally, these water-insoluble pesticides can be applied to a site in three ways, 1) as a dust, 2) as a solution in an organic solvent or a combination of water and one or more organic solvents, or 3) as an emulsion that is prepared by dissolving the product in an organic solvent, then dispersing the solution in water. All of these approaches have drawbacks. Application of a dust poses a health hazard and is inefficient. Solutions and emulsions that require an organic solvent are undesirable since the solvent usually serves no other purpose but to act as a carrier for the product. As such, the solvent adds an unnecessary cost to the formulation. It would be an advantage in the art, therefore, to provide a pesticide formulation that eliminates the need for organic solvents, on the one hand, but exhibits optimal availability to the site to which it is applied.

### SUMMARY OF THE INVENTION

The present invention provides a composition comprising a stable aqueous dispersion of from about 1 to about 60 percent by weight of a pesticide, based on the weight of water and the pesticide, wherein the pesticide has (a) a water solubility of less than 0.1 percent, and (b) a melting point sufficiently high so as not to melt during milling; wherein the dispersion contains a stabilizing amount of a surface active agent, and wherein the dispersion has a volume mean diameter particle size of not greater than about 450 nanometers (nm).

In a second aspect, the present invention is a method of preparing a stable aqueous pesticidal dispersion comprising the steps of:

a) mixing a pesticide with a stabilizing amount of a surface active agent and a sufficient amount of water to give an aqueous dispersion in the range of about 1 to about 60 weight percent, based on the weight of water, the surface active agent, and the pesticide; and

b) reducing the volume mean diameter particle size of the pesticide to not greater than 450 nm using mechanical means and a grinding medium.

The present invention addresses a need in the art by providing aqueous dispersions of submicron-sized particles having high bioavailability and no or minimal amounts of an ancillary organic solvent.

### DETAILED DESCRIPTION OF THE INVENTION

The stable aqueous dispersion of the pesticide can be prepared by wet milling an aqueous dispersion of the pesticide in the presence of grinding media and a surface active agent. As used herein, the term “a surface active agent” means one or more surface active agents. The preparation is carried out in such a manner so as to produce a dispersion of non-agglomerating or interacting particles having a volume median diameter of not greater than about 450 nm, more preferably not greater than about 400 nm, most preferably not greater than about 200 nm, as measured by a Horiba model LA-700 particle size analyzer or an equivalent method. An example of such preparation can be found in U.S. Pat. No. 5,145,684, which teachings are incorporated herein by reference.

The pesticide is a solid at ambient temperature, and has a melting point that is sufficiently high that the pesticide does not melt through the milling process. The pesticide is preferably crystalline, and is substantially water insoluble. The term substantially water insoluble is used herein to refer to a pesticide that has a solubility in water of less than about 0.1%, and most preferably less than about 0.01%. It is understood that the water solubilities of many pesticides are pH-dependent, as a result of the functional groups they contain. Thus, pesticides with carboxylic acid groups or with sulfonamide or sulfonylurea groups, for example, may meet the solubility requirements at low pH but may be too soluble at high pH. The pH of the aqueous dispersion can be adjusted to ensure substantial insolubility of these pesticides.

Pesticides include herbicides, insecticides, and fungicides. Examples of classes of compounds that have herbicidal activity and meet the solubility, crystallinity and melting point requirements include, but are not restricted to, imidazolinones such as imazaquin, sulfonylureas such as chlorimuron-ethyl, triazolopyrimidine sulfonamides such as flumetsulam, aryloxyphenoxy propionates such as quizalofop ethyl, aryl ureas such as isoproturon and chlorotoluron, triazines such as atrazine and simazine, aryl carboxylic acids such as picloram, aryloxy alkanoic acids such as MCPA, chloroacetanilides such as metazachlor, dintroanilines such as oryzalin, pyrazoles such as pyrazolynate and diphenyl ethers such as bifenox.

Examples of classes of compounds that have insecticidal activity and meet the solubility, crystallinity and melting point requirements include, but are not restricted to, benzoyl ureas such as hexaflumuron, diacylhydrazines such as tebufenozide, carbamates such as carbofuran, pyrethroids such as alpha-cypermethrin, organophosphates such as phosmet, triazoles, and natural products such as spinosyns.

Examples of classes of compounds that have fungicidal activity and meet the solubility, crystallinity and melting point requirements include, but are not restricted to, morpholines such as dimethomorph, phenylamides such as benalaxyl, azoles such as hexaconazole, strobilurins such as azoxystrobin, phthalonitriles such as chlorothalonil and phenoxyquinolines such as quinoxyfen.

The surface active agent may be anionic, cationic, or nonionic, or combinations of cationic and nonionic or anionic and nonionic. Generally, and to a point, higher concentrations of surface active agent result in smaller particle size. Examples of suitable classes of surface active agents include, but are not limited to, anionics such as alkali metal fatty acid salts, including alkali metal oleates and stearates; alkali metal lauryl sulfates; alkali metal salts of diisooctyl sulfosuccinate; alkyl aryl sulfates or sulfonates, alkali metal alkylbenzene sulfonates, such as dodecylbenzene sulfonate; and alkali metal soaps; cationics such as long chain alkyl quaternary ammonium surfactants including cetyl trimethyl ammonium bromide; or nonionics such as ethoxylated derivatives of fatty alcohols, alkyl phenols, amines, fatty acids, fatty esters, mono-, di-, or triglycerides, various block copolymeric surfactants derived from ethylene oxide/propylene oxide, polyvinyl alcohol, polyvinyl pyrrolidinone, and cellulose derivatives such as hydroxymethyl cellulose (commercially available as METHOCELTM noun, a trademark of The Dow Chemical Company). A stabilizing amount of the surface active agent is used, preferably not less than about 1%, and not more than about 30% by weight, based on the total weight of the water, the pesticide, and the surface active agent. The surface active agent is preferably adsorbed onto the surface of the pesticide particle in accordance with U.S. Pat. No. 5,145,684.

Examples of commercially available surface active agents include Atlox 4991 and 4913 surfactants (Uniqema), Morwet D425 surfactant (Witco), Pluronic P105 surfactant (BASF), Iconol TDA-6 surfactant (BASF), Kraftsperse 25M surfactant (Westvaco), Nipol 2782 surfactant (Stepan), Soprophor FL surfactant (Rhone-Poulenc), and Empicol LX 28 surfactant (Albright & Wilson).

The stable aqueous dispersions of the present invention can be prepared in the following manner. First, the pesticide is dispersed, preferably as a relatively coarse material having a particle size of less than about 100 μm. Such a degree of coarseness can be achieved, for example, by sieving. The coarse material is dispersed in an aqueous solution containing the surface active agent and preferably an antifoaming agent such as Antifoam B (Dow Corning) to form a premix. The premix can then be ground mechanically to reduce further the particle size of the pesticide. The concentration of the pesticide is in the range of from about 1% to about 60%, more preferably to about 30%, by weight based on the weight of the pesticide and the water. Attrition time can vary widely depending on the mechanical means used and the choice and concentration of surfactant.

Examples of mechanical means to reduce the size of the agricultural product include a ball mill, a roller miller, an attritor mill, a sand mill, a bead mill, and a Cowles type mixer. The grinding media used for particle size reduction preferably include substantially spheroidal shaped particles having an average size of less than 3 mm. Examples of suitable media material include ZrO stabilized with magnesia, zirconium silicate, glass, stainless steel, polymeric beads, alumina, and titania, although the nature of the material is not believed to be critical.

The particles are reduced in size at any suitable temperature where the agricultural product is stable. Typically, processing temperatures are not greater than the boiling point of water and below the melting point of the solid, but ambient temperature is preferred. The final volume mean diameter particle size is less than about 450 microns, more preferably less than about 400 nm, and most preferably less than about 200 nm.

The stable aqueous dispersions are preferably diluted with water, then applied to a site in a pesticidally effective amount.

One of the advantages of the stable aqueous dispersion of the present invention is that it provides a means to prepare one-part formulations of different pesticides which are not only compatible with each other, but incompatible or unstable in each other's presence as well. For example, it may be desirable to combine a certain pesticide with a certain herbicide for a particular application but for the fact that the two (in solution, for example) react with each other faster than they can be applied to the desired site. However, in a stable aqueous dispersion, these different and incompatible pesticides can coexist, at least temporarily, since they are shielded from each other from reacting rapidly, so that an end user can mix the incompatible pesticides together and apply them to a site before their efficacy is significantly diminished.

The fine particle size suspensions prepared according to the methods of the present invention, have enhanced biological efficacy as a result of their increased surface area as compared to suspensions of greater particle size. Theoretically, a reduction of volume mean diameter particle size of merely 10% can increase bioavailability by about 20%. Combined with the increased solubility of submicron particles (as predicted by the Kelvin equation), this increase in bioavailability can lead to significant increases in biological efficacy. Enhanced biological efficacy is particularly important in cases where pesticide solubility is very low and thus, biological availability is restricted.

The following examples are for illustrative purposes only and are not intended to limit the scope of the invention. All percentages are by weight unless otherwise specified. All particle sizes (measured using a Horiba model LA-700 particle size analyzer) are in units of volume mean diameter.

### EXAMPLE 1

### Preparation of a Stable Aqueous Nano-Dispersion of a Triazole

1-Methyl-3-(2-fluoro-6-chlorophenyl)-5-(3-methyl-4-bromothien-2-yl)-1H-1,2,4-triazole (1 g) was placed in a 20 mL polyethylene scintillation vial along with an aqueous phase (9 g) that was prepared by combining Pluronic P105 surfactant (3.33%), Morwet D425 surfactant (2.22%), deionized water (93.33%) and Antifoam B antifoaming agent (1.11%). About 10 g of ⅛″ diameter stainless steel ball bearings were added, and the vial was then sealed, and placed a Retsch Model MM 2000 mill. The sample was milled for 90 minutes and the particle size (pre-mill) was measured to be 1520 nm. A portion of the pre-mill (1 g) was removed and added to a fresh vial, at which time 1 drop of the antifoaming agent was added. Milling was continued for 3 hours, after which the particle size was determined to be 183 nm.

### EXAMPLE 2

### Preparation of a Stable Aqueous Nano-Dispersion Using Polymeric Beads

Example 1 was repeated except that styrene/divinylbenzene copolymer beads (475 μm diameter) were used instead of stainless steel beads. After the pre-mill was subjected to 120 minutes of additional milling, the particle size was determined to be 148 nm.

### EXAMPLE 3

### Preparation of a Stable Aqueous Nano-Dispersion Using Alternative Surfactant Package

Example 1 was repeated except that the aqueous phase was prepared using Atlox 4991 surfactant (6%), Atlox 4913 surfactant (12%), deionized water (78%) and Antifoam B (4%). After the pre-mill was subjected to 270 minutes of additional milling, the particle size was determined to be 163 nm.

### EXAMPLE 4

### Preparation of a Stable Aqueous Nano-Dispersion of Spinosad

In this example, Spinosad insecticide was milled. Again, Example 1 conditions were used except that the dispersion was prepared using the surfactant package described in Example 3. After the pre-mill was subjected to 195 minutes of additional milling, the particle size was determined to be 297 nm.

### EXAMPLE 5

### Preparation of a Stable Aqueous Nano-Dispersion of Spinosad Using a Different Surfactant Package

The conditions of Example 1 were repeated except the Spinosad was used instead of the triazole. After the pre-mill was subjected to 315 minutes of additional milling, the particle size was found to be 281 nm.

### EXAMPLE 6

### Preparation of a Stable Aqueous Nano-Dispersion of Atrazine Herbicide

Atrazine herbicide (1 g) was placed in a 20 mL polyethylene scintillation vial along with an aqueous phase (9 g) prepared by combining Iconol TD-6 surfactant (0.5 g) deionized water (8 g) and Antifoam B (0.5 g). About 10 g of ⅛″ stainless steel ball bearings were added, and the vial was sealed and placed on the mill. The particles were milled for 30 minutes, after which time a portion of the pre-mill (1 g) was removed and placed in a fresh vial along with fresh ball bearings (10 g) and 1 drop of Antifoam B. The vial was sealed and subjected to milling for an additional 105 minutes. Then Nipol 2782 surfactant (0.2 g) was added and milling was continued for an additional 2 hours. The particle size was measured to be 167 nm.

### EXAMPLE 7

### Preparation of a Stable Aqueous Nano-Dispersion of Epoxiconazole Fungicide

Epoxiconazole was placed in a 20 mL polyethylene scintillation vial along with an aqueous phase prepared from Soprophor FL surfactant (0.2 g), Empicol LX 28 (0.3 g), deionized water (8.45 g), and Antifoam B agent (0.05 g). About 10 g of ⅛″ steel ball bearings were added, and the vial was sealed and placed on the mill for 30 minutes, after which time, a portion of the pre-mill (1 g) was removed and placed in a fresh vial along with fresh ball bearings (10 g) and 1 drop of Antifoam B. The vial was sealed and subjected to milling for an additional 405 minutes. The particle size was measured to be 314 nm.

A correlation between particle size for Compound W and biological efficacy as demonstrated by the LC₅₀ values is shown in Table I below.

TABLE I
Two spotted spider mite

| VMD/nm | LC₅₀ |
|---|---|
| 0.404 | 15 |
| 0.372 | 11 |
| 0.332 | 7.6 |
| 0.163 | 4 |

As shown by the table, the amount required to kill 50% of the spider mites is substantially reduced at smaller VMD.

What is claimed is:

1. A composition comprising a stable aqueous dispersion of from about 1 to about 60 percent by weight of a pesticide, based on the weight of water and the pesticide, wherein the pesticide has (a) a water solubility of less than 0.1 percent, and (b) a melting point sufficiently high so as not to melt during milling; wherein the dispersion contains a stabilizing amount of a surface active agent, and wherein the dispersion has a volume mean diameter particle size of not greater than about 450 nanometers (nm).

2. The pesticidal dispersion of claim 1 wherein the pesticide is a herbicide selected from the group consisting of imidazolinones, sulfonylureas, triazolopyrimidine sulfonamides, aryloxyphenoxy propionates, aryl ureas, triazines, aryl carboxylic acids, aryloxy alkanoic acids, chloroacetanilides, dintroanilines, pyrazoles, and diphenyl ethers.

3. The pesiticidal dispersion of claim 1 wherein the pesticide is an insecticide selected from the groups consisting of benzoyl ureas, diacylhydrazines, carbamates, pyrethroids, organophosphates, triazoles and natural products.

4. The pesticidal dispersion of claim 1 wherein the pesticide is a fungicide selected from the group consisting of morpholines, phenylamides, azoles, strobilurins, phthalonitriles, and phenoxyquinolines.

5. The pesticidal dispersion of claim 1 wherein the pesticide has a crystalline phase and the surface active agent is selected from the group consisting of alkali metal fatty acid salts, polyoxyethylene nonionics, alkali metal lauryl sulfates, quaternary ammonium surfactants, alkali metal alkylbenzene sulfonates, alkali metal soaps, and polyvinyl alcohol, wherein the surface active agent is present at a concentration of from about 1 to about 30 weight percent based on the weight of the water, the pesticide and the surface active agent.

6. The pesticidal dispersion of claim 1 which has a volume mean diameter of not greater than about 200 nm.

7. A method for controlling pests comprising the step of diluting the stable aqueous dispersion of claim 1 with water and applying to a site a pesticidally effective amount of the diluted dispersion.

8. A method of preparing a stable aqueous pesticidal dispersion comprising the steps of:
a) mixing a pesticide with a stabilizing amount of a surface active agent and a sufficient amount of water to give an aqueous dispersion in the range of about 1 to about 60 weight percent, based on the weight of water, the surface active agent, and the pesticide; and
b) reducing the volume mean diameter particle size of the pesticide to not greater than 450 nm using mechanical means and a grinding medium.

9. The method of claim 8 wherein the mechanical means is a ball mill, a roller mill, an attritor mill, a sand mill, a bead mill, or a Cowles type mixer.

10. The method of claim 9 wherein the grinding media are substantially spheroidal shaped particles having an average size of less than 3 mm.

11. The method of claim 10 wherein the grinding media are particles selected from the group consisting of ZrO stabilized with magnesia, zirconium silicate, glass, stainless steel, polymeric beads, alumina, and titania.

12. The method of claim 11 wherein the grinding media are stainless steel.

13. The method of claim 11 wherein the grinding media are polymeric beads.
